(19) United States
(12) Patent Application Publication
(10) Pub. No.: US 2010/0038480 A1
(43) Pub. Date: Feb. 18, 2010

(54) JET/EFFLUX OUTWASH BARRIER SYSTEM FOR STOVL, TILTROTOR, AND HELICOPTER AIRCRAFT

(75) Inventors: Kuang-Ming Wu, McLean, VA (US); Timothy A. Roberts, Arlington, VA (US)

Correspondence Address: STEPTOE & JOHNSON LLP, 1330 CONNECTICUT AVENUE, N.W., WASHINGTON, DC, 20036, US

(73) Assignee: CNA Corporation, Alexandria, VA (US)

(21) Appl. No.: 12/191,914

(22) Filed: Aug. 14, 2008

(51) Int. Cl. B64F 1/26

(52) U.S. Cl. 244/114 B

(57) ABSTRACT

A barrier system for aircraft outwash flowing on an aircraft landing surface includes a plurality of barrier panel assemblies. Each of the barrier panel assemblies has a first end disposed adjacent a second end of another of the barrier panel assemblies, and each of the barrier panel assemblies has a flow surface for confining and mitigating aircraft outwash.

### STATEMENT AS TO RIGHTS TO INVENTIONS MADE UNDER FEDERALLY-SPONSORED RESEARCH AND DEVELOPMENT

This invention was made with U.S. government support under contract number N00014-05-D-0500 from the Office of Naval Research. The U.S. government has certain rights in the invention.

### FIELD OF THE INVENTION

The invention relates to barriers for jet/efflux outwash from aircraft. More particularly, the invention relates to barriers for aircraft jet/efflux outwash initially flowing toward a landing surface.

### BACKGROUND OF THE INVENTION

A short takeoff and vertical landing (STOVL) aircraft is equipped with rotatable jet nozzle(s) that, during the short-range takeoff and landing operations, produce a jet plume directed downward onto the runway or other landing surface creating tremendously strong and hot airflows, known as outwash, in all radial directions parallel to the surface. Similarly, helicopters and tiltrotor aircraft (like the V-22 Osprey) have rotors which direct their efflux airflow and engine exhaust downward onto the runway/helipad or other landing surface creating powerful outwash on the surface.

The all-radial-direction outwash of extreme pressure and temperature poses a severe hazard to ground personnel, equipment, and even other aircraft in close proximity. In particular, because the outwash flow is generated around the aircraft throughout the short-range takeoff and landing processes of STOVL aircraft, it affects a wide swath along the landing area and for example can disrupt operations of a runway with limited space such as an aircraft carrier deck.

Aircraft carriers are presently equipped with huge jet blast deflectors (JBDs), approximately 9 feet tall and 15 feet wide, that deflect the jet plume of aircraft undergoing catapult launch. These shipboard JBDs have the following characteristics:

1. Deflection without confinement or mitigation: JBDs are disposed normal to the jet plume path with distinctive inclination angles for deflecting the plume into open space. The deflected plume nevertheless can still be lethal. Hence, an open space beyond the deflector is required and without which a deflector would be rendered inadequate.

2. Costly construction and configuration: For close-in protection, JBDs are formed with high-temperature alloys coupled with cooling systems to sustain the direct, extreme heating from jet plumes.

3. Shipboard JBDs require massive supporting/operating mechanisms below the flight deck for sustaining the direct impact from jet plumes.

Such huge JBDs offer point-protection during the launch of conventional jet aircraft with horizontally-pointed jet nozzles and relatively narrow plume, but they do not offer wide-area-protection against the all-radial-direction outwash (although its temperature and pressure are much reduced from those of the plume) originating from STOVL aircraft and helicopters.

In the case of helicopters, to reduce the efflux/outwash pressure on the landing surface (e.g., ground, roof top, or ship deck), it is common for a helicopter to land on a pedestal that stands about 10 feet above the surface. Such an increase in helicopter height above the surrounding surface does reduce the outwash pressure to an extent. However, after the helicopter has landed, a steel-wire net is raised around the edge of the pedestal to guard the safety of exiting passengers. But this net should not be mistaken as an outwash barrier system.

Operations of STOVL aircraft thus necessitate massive safety precautions in order to protect other aircraft, equipment, and personnel. During STOVL operation of an AV-8B Harrier II Plus, for example, deck personnel cannot be within 50 feet of the aircraft due to the strong, hot outwash. Similarly, the outwash from STOVL operation of an F-35B Lightning II is likely to require a larger keep-out area. Such restrictions as a result of outwash intensity are disruptive to operations and thus do not permit efficient streamlining of operations.

Aircraft such as the AV-8B Harrier II Plus, F-35B Lightning II, and V-22 Osprey are suitable for takeoff and landing in confined areas. Such a confined area for example may be a flight deck on a naval vessel, which may be only 120 feet wide. Another confined area may be an airfield with limited space such as an unpaved, short airfield surrounded by wooded areas, as may be created for covert operations. In the latter case, the hot outwash can scorch ground and wooded areas around the takeoff and landing, potentially “highlighting” the location to enemy forces and thereby compromising the usefulness of the airfield. Yet another confined area, for example, could be the grounds of the White House which would need suitable protection from the effects of outwash from such aircraft when taking off and landing such as during a Presidential detail.

In view of the foregoing, there remains a need for a barrier system that effectively confines and mitigates the jet/efflux outwash flow originating from aircraft such as STOVL and helicopter aircraft during takeoff and landing operations and provides a safe and efficient operational environment for a carrier deck, airstrip/helipad, or other landing area for example with limited space. There is a need for a barrier system that not only confines (reorients) outwash, but also mitigates the outwash (e.g., slows it down and/or decreases the temperature rise that otherwise would occur on the side of the barrier system opposite to that directly receiving the outwash). There also remains a need for a barrier system that minimizes the cost and effort required in modifying relevant mechanisms above and below the flight deck of an aircraft carrier to accommodate the barrier system.

### SUMMARY OF THE INVENTION

During takeoff and landing, the STOVL, tiltrotor, and helicopter aircraft generate very strong, hot outwash flow parallel to the runway surface in every radial direction, which can inflict damage on personnel and equipment in close proximity. A jet/efflux outwash barrier system is designed to confine and mitigate the outwash flow, to shield ground personnel and equipment from extreme pressure and heat, and ultimately to streamline the operations on a carrier deck, airstrip, or other landing area of limited space.

A jet/efflux outwash barrier system (made of metallic alloys, ceramics, or composite materials) is configured and designed to confine and mitigate the outwash flow from STOVL, tiltrotor, and helicopter aircraft.

A barrier system for aircraft outwash flowing on an aircraft takeoff and landing surface includes a plurality of barrier panel assemblies, each of the barrier panel assemblies having a first end disposed adjacent a second end of another of the barrier panel assemblies, and each of the barrier panel assemblies including a substantially upright flow surface for confining and mitigating aircraft outwash. The plurality of barrier panel assemblies may be selected to extend substantially along the aircraft takeoff and landing surface for a span selected from the group consisting of a span to accommodate a short takeoff and vertical landing aircraft and a span to accommodate a vertical takeoff and landing aircraft. The aircraft takeoff and landing surface may be a runway. In some embodiments, at least two of the barrier panel assemblies may be offset from each other to provide an opening therebetween. The flow surfaces of at least two of the barrier panel assemblies may be disposed substantially in the same plane. Each of the barrier panel assemblies may have a bottom surface disposed adjacent an aircraft takeoff and landing surface and the bottom surfaces of at least two of the barrier panel assemblies may be substantially co-linearly disposed. At least two of the barrier panel assemblies may be disposed parallel to and spaced from each other and have different heights from each other.

In some embodiments, the aircraft takeoff and landing surface may be generally circular with a circumference, and the barrier panel assemblies may form a substantially contiguous barrier proximate the circumference.

The aircraft takeoff and landing surface may be generally circular with a circumference and the barrier panel assemblies may form an arcuate barrier proximate the circumference. At least two of the barrier panel assemblies may have different heights from each other.

The aircraft takeoff and landing surface may be on a marine vessel. The aircraft takeoff and landing surface may be a rotorcraft landing pad.

The outwash may be formed by a jet plume, efflux airflow, and/or engine exhaust after impingement on the aircraft takeoff and landing surface.

Each barrier panel assembly includes a panel pivotally mounted and movable between a raised state and a retracted state, with the panel having the substantially upright flow surface, such that in the retracted state the flow surface is not upright with respect to the aircraft takeoff and landing surface. Each barrier panel assembly may further include an actuation system for raising and retracting the panel. The actuation system may resist movement of the panel when the actuation system is not engaged. The actuation system may be hydraulically operable, electrically driven, and/or driven by human power. The panel may be movable to a fully retracted state with the flow surface generally parallel to and/or generally flush with the aircraft takeoff and landing surface, and the panel may be movable to a fully raised state with the flow surface generally perpendicular to the aircraft takeoff and landing surface. The flow surface may be generally upright.

In some embodiments, the barrier panel assembly may be generally L-shaped.

A method of mitigating aircraft outwash flowing on an aircraft takeoff and landing surface may include: providing a barrier system comprising a plurality of barrier panel assemblies, each of the barrier panel assemblies having a first end disposed adjacent a second end of another of the barrier panel assemblies, and each of the barrier panel assemblies comprising a flow surface, wherein the plurality of barrier panel assemblies are selected to extend substantially along the aircraft takeoff and landing surface for a span selected from the group consisting of a span to accommodate a short takeoff and vertical landing aircraft and a span to accommodate a vertical takeoff and landing aircraft; and orienting the flow surfaces to confine and mitigate aircraft outwash.

The aircraft takeoff and landing surface may be a runway and the method may further include positioning the barrier system generally parallel to a centerline of the runway and spaced therefrom to accommodate unimpeded travel of an aircraft on the runway generally along the centerline. At least two of the barrier panel assemblies may be disposed parallel to and spaced from each other and have different heights from each other.

In some embodiments, the aircraft takeoff and landing surface may be generally circular with a circumference, and the method may further include positioning the barrier panel assemblies to form an arcuate barrier proximate the circumference. At least two of the barrier panel assemblies may have different heights from each other. The aircraft takeoff and landing surface may be on a marine vessel. The aircraft takeoff and landing surface may be a rotorcraft landing pad. The outwash may be formed by a jet plume, efflux airflow, and/or engine exhaust after impingement on the aircraft takeoff and landing surface. The barrier system may be installed close to the site of impingement of the jet plume, efflux airflow, and/or engine exhaust.

The method may further include retracting the flow surface. The flow surface may be fully retracted to be generally parallel to and/or flush with the aircraft takeoff and landing surface.

In some embodiments, in combination with an aircraft runway, an outwash barrier system includes a plurality of outwash barriers disposed in an end-to-end manner, substantially parallel to the runway for a substantial length thereof, with each barrier having a surface for being exposed to aircraft outwash flow, and with the barriers being disposed at an offset from a centerline of the runway to allow space for aircraft operations generally along the centerline. Each barrier may include a panel disposed in a generally upright configuration. In some embodiments, each barrier may include a panel pivotally mounted and movable between a raised configuration and a retracted configuration. Each barrier further may include an actuation mechanism for raising, retracting, and locking the panel in the configurations. The actuation mechanism may be human powered, hydraulically operable, and/or electrically operable. In the retracted configuration, the surface for being exposed to aircraft outwash flow of each panel may be disposed generally parallel to and/or flush with the surface on which the outwash barrier is mounted (e.g., the runway). In some embodiments, a plurality of outwash barriers may be disposed in an end-to-end manner, substantially parallel to the runway for a substantial length thereof, spaced from the centerline on both sides of the centerline.

In some embodiments, in combination with an aircraft landing pad, an outwash barrier system includes a plurality of outwash barriers disposed generally upright with a surface of each outwash barrier for being exposed to outwash flow, the outwash barriers disposed at an offset from a center of the landing pad to allow space for aircraft operations, and with the outwash barriers being aligned in an end-to-end manner that circumscribes the landing pad for a substantial sector thereof. Each barrier may include a panel disposed in a generally upright configuration. In some embodiments, each barrier may include a panel pivotally mounted and movable between a raised configuration and a retracted configuration. Each barrier further may include an actuation mechanism for raising, retracting, and locking the panel in the configurations. The actuation mechanism may be human powered, hydraulically operable, and/or electrically operable. In the retracted configuration, the surface of each outwash barrier for being exposed to outwash flow may be disposed generally parallel to and/or flush with the surface on which the outwash barrier is mounted (e.g., the runway).

### BRIEF DESCRIPTION OF THE DRAWINGS

Preferred features of embodiments are disclosed in the accompanying drawings, in which hollow arrowheads indicate directions of jet plume, efflux, and outwash flow, wherein:

FIG. 1 shows a front view of a STOVL aircraft above a takeoff and landing surface, with arrows indicating the all-radial-direction outwash flow generated by the downward jet plume from the aircraft;

FIG. 2 shows a side view of a helicopter above a takeoff and landing surface, with arrows indicating the all-radial-direction outwash flow generated by the downward efflux from the helicopter;

FIG. 3 shows a side perspective view of an embodiment with two outwash barrier systems (or, alternatively, a single outwash barrier system with an opening) for protecting personnel and parked aircraft on one side of a STOVL runway, an opening being provided between the barrier system(s) proximate a ground spot where such barriers cannot be located;

FIG. 4 shows a side perspective view of another embodiment with an outwash barrier system for protecting personnel outside a helipad, with barrier panels of various heights and geometries provided including a pair of barrier panels positioned adjacent to a ground spot on which such barriers cannot be located;

FIG. 5(a) shows a side view of a pivotally mounted barrier panel disposed in a raised configuration;

FIG. 5(b) shows the pivotally mounted barrier panel of FIG. 5(a) disposed in a partially retracted configuration using an actuation mechanism;

FIG. 6 shows a side view of a non-pivotable barrier suitable for use in a barrier system as disclosed herein;

FIG. 7 shows another side view of a non-pivotable barrier suitable for use in a barrier system as disclosed herein;

FIG. 8 shows another side view of a non-pivotable barrier suitable for use in a barrier system as disclosed herein; and

FIG. 9 shows another side view of a non-pivotable barrier suitable for use in a barrier system as disclosed herein.

### DETAILED DESCRIPTION OF THE PREFERRED EMBODIMENTS

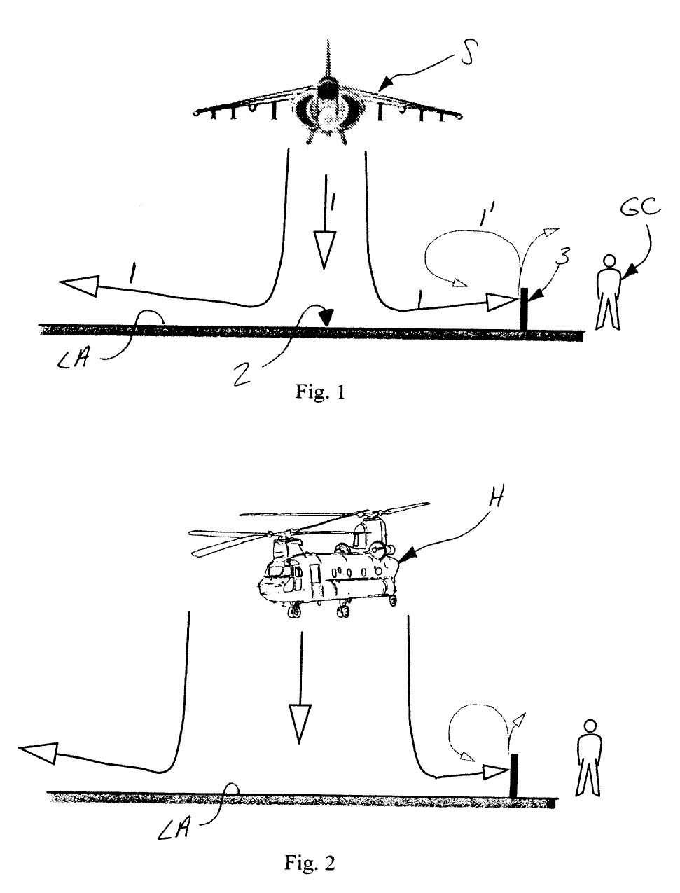

Turning first to FIGS. 1-2, the outwash flows generated by a STOVL aircraft S and a helicopter aircraft H (or tiltrotor), respectively, are shown. Outwash 1 increases height as it flows away from the spot of impingement 2 on landing area LA. Hence a barrier system 3 with fixed height is more effective in confining the outwash if it is installed close to the spot of impingement 2 and built of a structural material capable of sustaining the outwash pressure and temperature. Eventually the mitigated outwash 1′ will accumulate and overflow barrier system 3 with its pressure and temperature drastically reduced to a safe level so that, for example, a ground crew member GC may be positioned relatively close to the spot of impingement but behind barrier system 3.

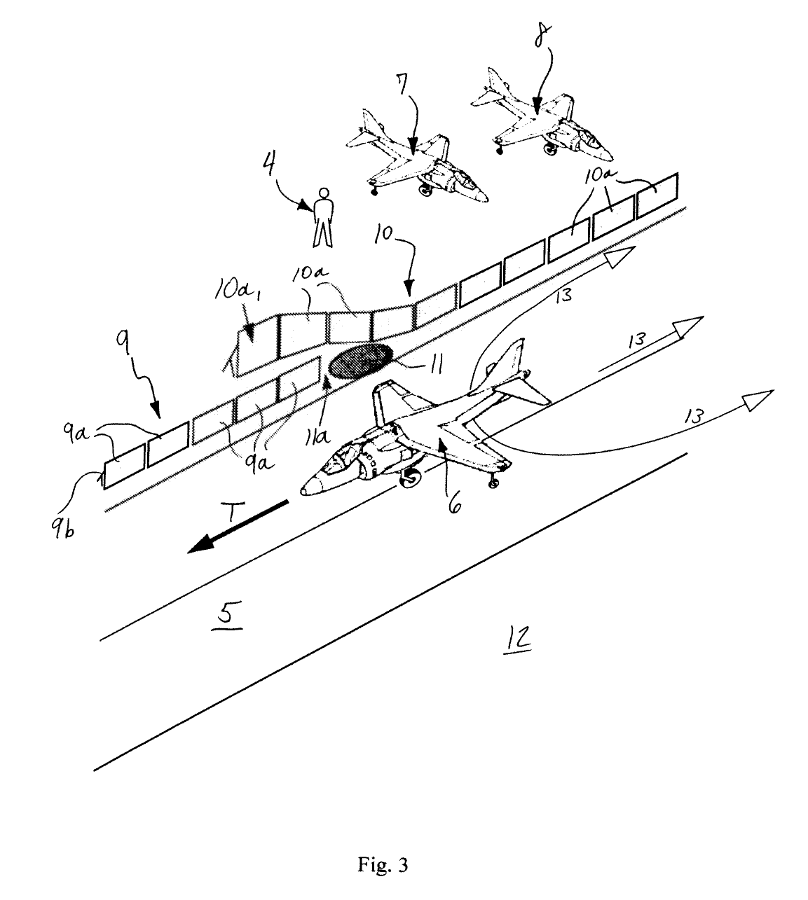

In a first exemplary, preferred embodiment shown in FIG. 3, a runway 5 is shown with a STOVL aircraft 6 conducting a short takeoff in the direction T while an onlooking person 4 and two other aircraft 7, 8 are parked not far from runway 5. Two outwash barrier systems 9, 10 are mounted close and generally parallel to runway 5. Each barrier system 9, 10 has a plurality of panels 9a, 10a, respectively, oriented end-to-end in a generally upright manner each with a surface generally facing the outwash flow. Each panel such as panel 9a may include a structural support 9b for maintaining orientation of the panel.

An opening 11a between two barrier systems 9, 10 is created for bypassing a ground spot 11 that cannot be obstructed by any barrier panels.

Barrier systems 9, 10 alternatively may be a single barrier system with opening 11a therein.

In an exemplary embodiment, the heights of the barrier panels increase proportionally to their distances from the centerline of the runway 5, as shown by the height of panel 10a₁. This increase is designed to cope with the height increase of outwash flowing outward from the impingement area. Thus, as shown in FIG. 3, panels 9a are disposed closer to runway 5 than panel 10a₁ and therefore panels 9a are shorter than panel 10a₁.

Depending on the existence, size, and shape of any ground spot 11, it instead may be possible to combine or otherwise link barrier systems 9, 10 into a single continuous barrier system without an opening 11a, and thus in some embodiments only a single continuous barrier system may be used.

It should also be noted that as shown in FIG. 3, a “forward” opening 11a between barrier systems 9, 10 still provides effective confinement and mitigation during STOVL takeoff because the outwash velocity components 13 are mostly oriented “aft.”

In FIG. 3, the STOVL runway 5 is shown with barrier systems 9, 10 disposed on only one side thereof. In the case of a naval vessel, for example, region 12 may be the ocean over which outwash may not need to be confined.

An exemplary STOVL aircraft for which the outwash barriers disclosed herein may be used is a Joint Strike Fighter F-35B Lightning II which has a height of 15 feet (4.6 m), a length of 51.1 feet (15.6 m), a wingspan of 35 feet (10.7 m), an engine thrust (dry) of 25,000 lb. (111 kN), an engine thrust with after burner of 40,000 lb. (178 kN), and a vertical thrust of 39,700 lb. (176.6 kN).

Another exemplary aircraft for which the outwash barriers disclosed herein may be used is a AV-8B Harrier II Plus, which also is a STOVL aircraft with a height of 11.65 feet, a length of 47.75 feet, a wingspan of 30.33 feet, an engine thrust (static) of 23,400 lb.

Yet another exemplary aircraft for which the outwash barriers disclosed herein may be used is a V-22 Osprey, a tiltrotor aircraft capable of vertical takeoff and landing (VTOL) as well as STOVL with a length of 57.3 feet (17.48 m), a width (rotors turning) of 84.6 feet (25.55 m), and a height (nacelles fully vertical) of 22.1 feet (6.73 m), and an engine shaft horsepower of 12,300 shp (9,172 kW).

From the deck of a warship, an aircraft takeoff may need to occur, for example, within 550 feet, while from a land-based, paved runway the takeoff distance, for example, may be a more generous 3,000 feet. A “soft-field” takeoff distance, for example, may be between 550 feet and 3,000 feet, for example 2,400 feet.

In an exemplary embodiment, the high temperature outwash is confined and mitigated by the barrier system such that the temperature increase on the side of the barrier system opposite to that directly receiving the outwash is substantially lowered. For example, when the outwash reaches the barrier system, it may have an outwash temperature of 1000° F., but on the opposite side of the barrier system the temperature may be only about 60%, only about 40%, or only about 20% of the outwash temperature. In some exemplary embodiments, during impingement of outwash on the barrier system, the barrier system may induce/achieve a temperature difference of at least 400° F., at least 600° F., or at least 800° F. between opposing sides thereof.

In some exemplary embodiments, the barrier system is located between about 30 feet and about 50 feet, or between about 30 feet and about 40 feet, from the centerline of a runway along which an aircraft such as described above would travel. In the case of a circular landing area such as for a rotorcraft described above, the barrier system for example may be located between about 30 feet and about 50 feet, or between about 30 feet and about 40 feet, from the center of the circular landing area.

In addition, in some exemplary embodiments, the barrier system is between about 2 feet and about 4 feet in height. Advantageously, such a height would permit personnel to see over the barrier system to view an aircraft during takeoff and landing operations.

In one exemplary embodiment, a barrier system is positioned between about 30 feet and about 40 feet from the centerline of a runway with a height between about 2 feet and about 4 feet. Advantageously, because the barrier system is located relatively close to the source of outwash, the outwash flow can be confined and mitigated from a relatively short height.

In some exemplary embodiments, a substantial portion of a flight deck on an aircraft carrier or a land-based runway along which an above-mentioned aircraft travels is provided with a barrier system. For example, a barrier system may be provided substantially over a length of about 550 feet, or substantially over a length between about 550 feet and about 1000 feet.

In the case of circular landing areas, the barrier system for example may be disposed along a radius of between about 30 feet and about 40 feet and may extend substantially entirely along the radius (e.g., for substantially 360°) or alternatively only may extend for a portion of the circumference such as at least about 40°, at least about 120°, or at least about 180°. Thus, for example, the barrier system may provide protection for one region of a naval vessel while not otherwise blocking flow of outwash over the side of the vessel.

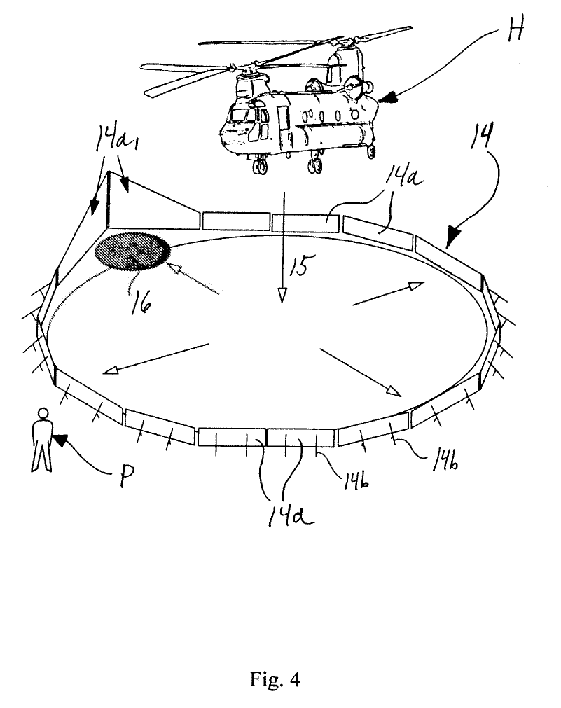

In a second exemplary, preferred embodiment, shown in FIG. 4, an outwash barrier system 14 having a plurality of panels 14a (with structural supports 14b) is disposed for example to protect personnel P positioned beyond the perimeter of a helipad from outwash 15. A pair of panels 14a₁ is shown with different geometry (e.g., trapezoidal) and height compared to the other panels 14a in barrier system 14. The use of panels 14a₁ advantageously permits barrier system 14 to also enclose ground spot 16 which preferably remains unobstructed by barrier system 14. In the exemplary embodiment, a generally circular helipad may be substantially surrounded by barrier system 14 disposed proximate the circumference of the helipad (while the space of ground spot 16 also is surrounded by barrier system 14). In some embodiments, an opening (not shown) may be provided to form a discontinuous barrier system (see for example opening 11a in FIG. 3).

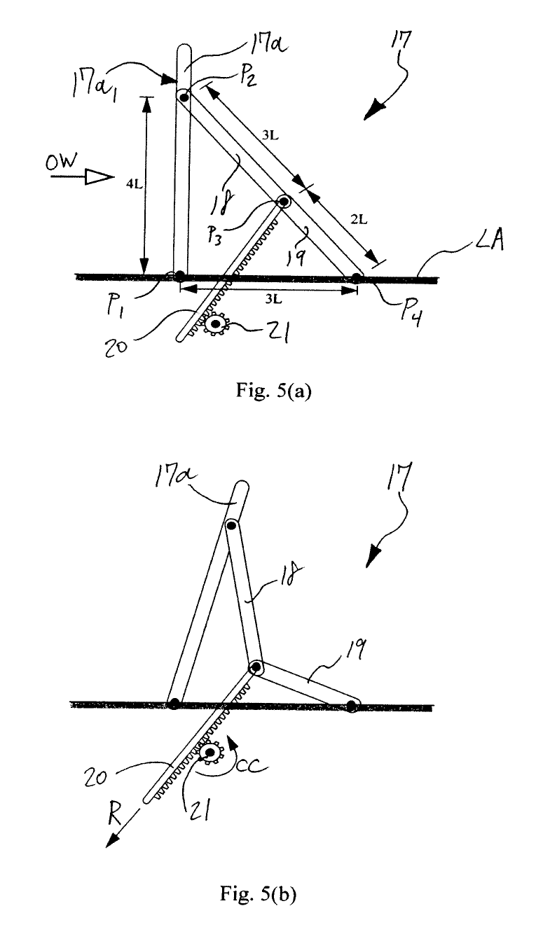

Referring next to FIG. 5(a), a pivotable barrier panel assembly 17 is shown in a raised state with panel 17a and particularly its surface 17a₁ disposed to resist pressure from outwash OW. For example, panel 17a may be oriented substantially perpendicular to landing surface LA. When links 18, 19 are in a co-linear configuration as shown, they for example resist outwash pressure against panel surface 17a and thus support the panel. In the exemplary embodiment, four pivot points P₁, P₂, P₃, P₄ are shown. Pivot points P₁, P₄ may be disposed proximate landing surface LA. Exemplary dimensions for components of panel assembly 17 are indicated by numbers multiplied by “L”, which represents a selected length unit. Thus, for example, link 18 is 1.5 times the length of link 19, with pivot point P₃ disposed proximate ends thereof and connecting links 18, 19. Pivot point P₂ connects panel 17a and link 18. A toothed link 20 is coupled to links 18, 19 at pivot point P₃ and is driven by sprocket 21, thus forming an actuation system for deploying or retracting panel 17a. As shown, link 20 may extend below surface LA and sprocket 21 also may be disposed below surface LA.

Barrier panel assembly 17 is shown in a partially retracted state in FIG. 5(b). Retraction of barrier panel 17a may be accomplished using the actuation system, with panel assembly 17 being retracted through the movement of toothed link 20 in direction R while being driven by sprocket 21 rotating in counter-clockwise direction CC in the side view shown. It also should be noted that when not turning, sprocket 21 serves as a locking mechanism for maintaining the barrier in the desired deployed or retracted state.

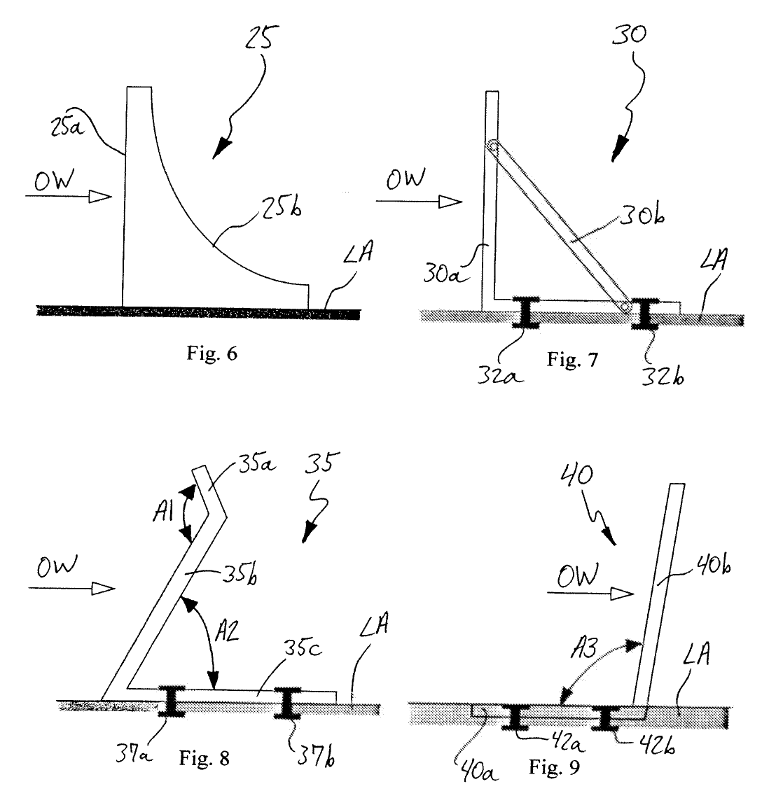

Additional alternate exemplary embodiments of barrier panel assemblies which are non-pivotable are shown in FIGS. 6-9. In particular, as shown in FIG. 6, barrier panel assembly 25 may be formed for example of unitary construction, may be solid or hollow, and may include a front face 25a on which outwash OW impinges and a rear portion 25b which may be arcuate in shape. Front face 25a may be disposed generally perpendicular to surface LA.

As shown in FIG. 7, barrier panel assembly 30 may be formed of an L-shaped member 30a with a support member 30b coupled to each of the legs of member 30a as shown. Again, a leg of L-shaped member 30a may be disposed generally perpendicular to surface LA to confine outwash OW. In an exemplary embodiment, barrier panel assembly 30 is coupled to surface LA with support beams 32a, 32b (shown in side view). Thus, if assembly 30 is formed of steel, it may be welded to beams 32a, 32b.

Yet another barrier panel assembly 35 is shown in FIG. 8. Assembly 35 includes three legs 35a, 35b, 35c. In the exemplary embodiment, legs 35a, 35b include surfaces on which outwash OW impinges, with legs 35a, 35b positioned so that their respective surfaces facing outwash OW are disposed at an angle A1 between about 90° and about 180°, and more preferably between about 110° and about 160°. In addition, legs 35b, 35c are positioned to define an angle A2 therebetween, with angle A2 preferably between about 0° and about 90°, and more preferably between about 20° and 70°. As with assembly 30, assembly 35 may be coupled to surface LA with support beams 37a, 37b (shown in side view).

Finally, turning to FIG. 9, barrier panel assembly 40 is generally L-shaped with legs 40a, 40b. Leg 40a is disposed below and flush with surface LA and is coupled to support beams 42a, 42b which also are below surface LA. The surface of leg 40b is disposed at an angle A3 with respect to the surface of leg 40a that is generally flush with LA. In an exemplary embodiment, legs 40a, 40b are disposed at an angle A3 of between about 70° and about 120°, more preferably between about 90° and about 120°.

While barrier panel assemblies 35, 40 are described as non-pivotable, in some embodiments the regions between adjacent legs thereof may serve as living hinges to some extent to allow limited flexing.

The barrier panel assemblies, for example, may be retractable so that they lie generally flush with the surface on which they are mounted (e.g., a runway or helipad area) so as not to obstruct traffic. Depending on the size of the barrier panel assemblies, they could obstruct traffic even when disposed generally parallel to the surface on which they are mounted, and thus in some embodiments the barrier panels may be arranged to be flush with the surface on which they are mounted when not in use confining and mitigating aircraft outwash.

The jet/efflux outwash barrier systems described herein may be used to confine and mitigate outwash flow from an aircraft to shield nearby ground personnel and equipment from extreme pressure and heat when the outwash impinges on a runway or other landing surface. Such systems, for example, ultimately may streamline the operations on a carrier deck or an airstrip of limited space.

In the exemplary embodiment shown in FIGS. 1-4, for example, remote from any “ground spots,” the barrier systems have a height less than the height of an average human being, and more preferably at least 1 foot lower than the height of an average human being.

While various descriptions of the present invention are described above, it should be understood that the various features can be used singly or in any combination thereof. Therefore, this invention is not to be limited to only the specifically preferred embodiments depicted herein.

Further, it should be understood that variations and modifications within the spirit and scope of the invention may occur to those skilled in the art to which the invention pertains. It should be understood that the forms of invention shown and described herein are to be taken as preferred embodiments thereof, and that various changes in shape, material, size, and arrangement of parts may be resorted to without departing from the spirit of invention. Accordingly, all expedient modifications readily attainable by one versed in the art from the disclosure set forth herein that are within the scope and spirit of the present invention are to be included as further embodiments of the present invention. The scope of the present invention is accordingly defined as set forth in the appended claims.

What is claimed is:

1. In combination with an aircraft runway, an outwash barrier system comprises a plurality of outwash barriers disposed in an end-to-end manner, substantially parallel to said runway for a substantial length thereof, each barrier comprising a surface for being exposed to aircraft outwash flow, with said barriers being disposed at an offset from a centerline of said runway to allow space for aircraft operations generally along said centerline.

2. The combination of claim 1, wherein each barrier comprises a panel disposed in a generally upright configuration.

3. The combination of claim 1, wherein each barrier comprises a panel pivotally mounted and movable between a raised configuration and a retracted configuration.

4. The combination of claim 3, wherein each barrier further comprises an actuation mechanism for raising, retracting, and locking said panel in said configurations.

5. The combination of claim 4, wherein said actuation mechanism is human powered.

6. The combination of claim 4, wherein said actuation mechanism is hydraulically operable.

7. The combination of claim 4, wherein said actuation mechanism is electrically operable.

8. The combination of claim 3, wherein in said retracted configuration, the surface for being exposed to aircraft outwash flow of each said panel is disposed generally parallel to surface on which said outwash barrier is mounted.

9. The combination of claim 3, wherein in said retracted configuration, the surface for being exposed to aircraft outwash flow of each said panel is disposed generally flush with surface on which said outwash barrier is mounted.

10. The combination of claim 1, wherein a plurality of outwash barriers are disposed in an end-to-end manner, substantially parallel to said runway for a substantial length thereof, spaced from said centerline on both sides of said centerline.

11. In combination with an aircraft landing pad, an outwash barrier system comprises a plurality of outwash barriers disposed generally upright with a surface of each outwash barrier for being exposed to outwash flow, said outwash barriers disposed at an offset from a center of said landing pad to allow space for aircraft operations, with the outwash barriers being aligned in an end-to-end manner that circumscribes said landing pad for a substantial sector thereof.

12. The combination of claim 11, wherein each barrier comprises a panel disposed in a generally upright configuration.

13. The combination of claim 11, wherein each barrier comprises a panel pivotally mounted and movable between a raised configuration and a retracted configuration.

14. The combination of claim 13, wherein each barrier further comprises an actuation mechanism for raising, retracting, and locking said panel in said configurations.

15. The combination of claim 13, wherein said actuation mechanism is human powered.

16. The combination of claim 13, wherein said actuation mechanism is hydraulically operable.

17. The combination of claim 13, wherein said actuation mechanism is electrically operable.

18. The combination of claim 13, wherein in said retracted configuration, the surface of each outwash barrier for being exposed to outwash flow is disposed generally parallel to surface on which said outwash barrier is mounted.

19. The combination of claim 13, wherein in said retracted configuration, the surface of each outwash barrier for being exposed to outwash flow is disposed generally flush with surface of which said outwash barrier is mounted.

20. A barrier system for aircraft outwash flowing on an aircraft takeoff and landing surface, the barrier system comprising a plurality of barrier panel assemblies, each of the barrier panel assemblies having a first end disposed adjacent a second end of another of the barrier panel assemblies, and each of the barrier panel assemblies comprising a substantially upright flow surface for confining and mitigating aircraft outwash, wherein the plurality of barrier panel assemblies are selected to extend substantially along the aircraft takeoff and landing surface for a span selected from the group consisting of a span to accommodate a short takeoff and vertical landing aircraft and a span to accommodate a vertical takeoff and landing aircraft.

21. The barrier system of claim 20, wherein the aircraft takeoff and landing surface is a runway.

22. The barrier system of claim 21, wherein at least two of the barrier panel assemblies are offset from each other to provide an opening therebetween.

23. The barrier system of claim 21, wherein the flow surfaces of at least two of the barrier panel assemblies are disposed substantially in the same plane.

24. The barrier system of claim 21, wherein at least two of the barrier panel assemblies are disposed parallel to and spaced from each other and have different heights from each other.

25. The barrier system of claim 20, wherein the aircraft takeoff and landing surface is generally circular with a circumference and the barrier panel assemblies form a substantially contiguous barrier proximate the circumference.

26. The barrier system of claim 20, wherein the aircraft takeoff and landing surface is generally circular with a circumference and the barrier panel assemblies form an arcuate barrier proximate the circumference.

27. The barrier system of claim 26, wherein at least two of the barrier panel assemblies have different heights from each other.

28. The barrier system of claim 20, wherein the aircraft takeoff and landing surface is on a marine vessel.

29. The barrier system of claim 20, wherein the aircraft takeoff and landing surface is a rotorcraft landing pad.

30. The barrier system of claim 20, wherein each barrier panel assembly comprises a panel pivotally mounted and movable between a raised state and a retracted state, the panel comprising the substantially upright flow surface, such that in the retracted state the flow surface is not upright with respect to the aircraft takeoff and landing surface.

31. The barrier system of claim 30, wherein each barrier panel assembly further comprises an actuation system for raising and retracting the panel.

32. The barrier system of claim 31, wherein the actuation system resists movement of the panel when the actuation system is not engaged.

33. The barrier system of claim 30, wherein the panel is movable to a fully retracted state generally parallel to the aircraft takeoff and landing surface.

34. The barrier system of claim 30, wherein the panel is movable to a fully retracted state generally flush with the aircraft takeoff and landing surface.

35. The barrier system of claim 30, wherein the panel is movable to a fully raised state generally perpendicular to the aircraft takeoff and landing surface.

36. A method of mitigating aircraft outwash flowing on an aircraft takeoff and landing surface, the method comprising:
providing a barrier system comprising a plurality of barrier panel assemblies, each of the barrier panel assemblies having a first end disposed adjacent a second end of another of the barrier panel assemblies, and each of the barrier panel assemblies comprising a flow surface, wherein the plurality of barrier panel assemblies are selected to extend substantially along the aircraft takeoff and landing surface for a span selected from the group consisting of a span to accommodate a short takeoff and vertical landing aircraft and a span to accommodate a vertical takeoff and landing aircraft;
orienting the flow surfaces to confine and mitigate aircraft outwash.

37. The method of claim 36, wherein the aircraft takeoff and landing surface is a runway and the method further comprises positioning the barrier system generally parallel to a centerline of the runway and spaced therefrom to accommodate unimpeded travel of an aircraft on the runway generally along the centerline.

38. The method of claim 36, wherein at least two of the barrier panel assemblies are disposed parallel to and spaced from each other and have different heights from each other.

39. The method of claim 36, wherein the aircraft takeoff and landing surface is generally circular with a circumference, and the method further comprises positioning the barrier panel assemblies to form an arcuate barrier proximate the circumference.

40. The method of claim 39, wherein at least two of the barrier panel assemblies have different heights from each other.

41. The method of claim 36, wherein the aircraft takeoff and landing surface is on a marine vessel.

42. The method of claim 36, wherein the aircraft takeoff and landing surface is a rotorcraft landing pad.

43. The method of claim 36, further comprising:
retracting the flow surface.

44. The method of claim 43, wherein the flow surface is fully retracted to be generally parallel to the aircraft takeoff and landing surface.

45. The method of claim 43, wherein the flow surface is fully retracted to be generally flush with the aircraft takeoff and landing surface.
